(19) United States
(12) Patent Application Publication
(10) Pub. No.: US 2018/0243782 A1
(43) Pub. Date: Aug. 30, 2018

(54) AUTOMATED PRIMER APPLICATION SYSTEM

(71) Applicant: SAINT-GOBAIN GLASS FRANCE, Courbevoie (FR)

(72) Inventors: Uwe WEISSENBERGER, WUERZBURG (DE); Thomas LUX, WEISSACH IM TAL (DE); Georg SCHNEIDER, WUERZBURG (DE); Guenay NALINCI, LUDWIGSBURG (DE)

(21) Appl. No.: 15/741,229

(22) PCT Filed: Sep. 29, 2016
(86) PCT No.: PCT/EP2016/073356

§ 371 Date: May 15, 2018

(30) Foreign Application Priority Data
Oct. 7, 2015 (EP) 15188780.9

(51) Int. Cl. B05C 1/06; B05C 1/02; B05C 1/14; B05C 11/10

(52) U.S. Cl. CPC B05C 1/06; B05C 1/027; D04H 1/425; B05C 11/1005; B05C 1/14

(57) ABSTRACT

An automated primer application system for producing attachment parts for means of transportation is disclosed. The system comprises an output reel, a take-up reel, an application head with a nozzle opening, and a high-pressure waterjet-consolidated polymer-cellulose nonwoven. The high-pressure waterjet-consolidated polymer-cellulose nonwoven is guided from the output reel over the application head to the take-up reel. The high-pressure waterjet-consolidated polymer-cellulose nonwoven is arranged in front of the nozzle opening. A primer liquid can be fed through the nozzle opening such that the primer liquid can be applied to a surface of a part via the polymer-cellulose nonwoven.

The present invention relates to an automated primer application system (PA) for producing an attachment part for means of transportation, a method for the controlled application of primer liquids on surfaces of attachment parts, and the use of high-pressure waterjet-consolidated polymer-cellulose nonwovens in such a method.

Application systems for primer liquids on main bodies of panes are known. They are used to prepare the main bodies of panes for gluing. Such primer liquids are usually applied to the panes manually via small bottles with a separate felt head, which entails some disadvantages as well as increased material cost. For example, the contour of the gluing line must be traveled very precisely in order to avoid primer defects or pools or runs. Also, the felt must be replaced periodically, always with a considerable amount of primer being lost.

With some automated methods, the primer liquid is applied on the pane using a robot arm, but working with felts here as well. These methods do, to be sure, enable precise deposition of primer, which, however, does not solve the problems associated with the use of felts. In addition, the felt head of the robot must be changed at regular intervals, which requires an additional mechanism.

Thus, for example, a liquid dispensing apparatus for applying liquids on a receiving surface is known from the German patent application DE 102 49 726 A1. The dispensing apparatus operates with a flow-through felt web. The dispensing apparatus can have one or a plurality of dispensing heads, each of which includes a dispensing gun and an articulated rub block. The articulated rub block includes a recess or galley immediately behind the felt in order to provide a small puddle of liquid material for soaking through the felt during a dispensing operation. The dispensing apparatus can be tilted such that only one dispensing head at a time is presented to the receiving surface. The galley has a geometry such that the bead profile of the liquid material dispensed onto the surface is improved. Liquid material is dispensed by means of relative lateral movement between the apparatus and the receiving surface. However, since the felt web is very flexible, the dispensing apparatus includes a complexly designed transport control in order to ensure reproducible dispensing of liquid.

The object of the present invention is, consequently, to remedy the above described disadvantages of the prior art in order, in particular, to reduce the material cost and to avoid primer defects, pools, or runs. Moreover, for application of liquids on surfaces, the use of felt webs and a complex transport control system should be avoided.

Overall, the application of liquids, in particular of primers, on surfaces, in particular the surface of vehicle attachment parts, most particularly of vehicle window panes, should be done in an exactly reproducible and material-saving manner.

Accordingly, the new automated primer application system PA for producing attachment parts for means of transportation was discovered, which includes a high-pressure waterjet-consolidated polymer-cellulose nonwoven and which is referred to in the following as the “application system PA according to the invention”. In it, the high-pressure waterjet-consolidated polymer-cellulose nonwoven is provided for application of a liquid.

Also discovered was the new method for the controlled application of primer liquids on surfaces, in which the primer application system PA according to the invention is used and which is referred to in the following as the “method according to the invention”.

And, last but not least, the new use of high-pressure waterjet-consolidated polymer-cellulose nonwovens in a method for producing attachment parts for means of transportation was discovered, which is referred to in the following as the “use according to the invention”.

In view of the prior art, it was surprising and unforeseeable for the person skilled in the art that the objects of the present invention could be accomplished using the application system PA according to the invention, the method according to the invention, and the use according to the invention. In particular, using the application system according to the invention and the method according to the invention, it was possible to remedy the above-described disadvantages of the prior art. Surprisingly, it was possible to reduce the material cost and to avoid primer defects or pools or runs. Also, it was possible to avoid the use of felt webs for the application of liquids on surfaces and a complex transport control system. Overall, the application of liquids, in particular of primer liquids on surfaces, in particular the surface of vehicle window panes, was exactly reproducible and cost-saving. But, above all, the application systems according to the invention got by with a minimum of movable parts such that the undesirable drying out of the liquids during application or in the parking position of the application systems according to the invention was significantly reduced or completely prevented. It was, in particular, surprising that a new, beneficial, and widely applicable use could be discovered for high-pressure waterjet-consolidated polymer-cellulose nonwovens.

The present invention relates to an automated primer application system for producing attachment parts for means of transportation. The automated primer application system includes at least a high-pressure waterjet-consolidated polymer-cellulose nonwoven, an output reel for clean, i.e., unused, high-pressure waterjet-consolidated polymer-cellulose nonwoven, and a take-up reel for used, i.e., already having been in contact with a surface of a part, high-pressure waterjet-consolidated polymer-cellulose nonwoven. Also, the automated primer application system includes an application head with a nozzle opening. The high-pressure waterjet-consolidated polymer-cellulose nonwoven is guided from the output reel over the application head to the take-up reel and is arranged in front of the nozzle opening. A primer liquid can be fed through the nozzle opening such that primer liquid can be applied on a surface of the part via the polymer-cellulose nonwoven.

During the application of liquids, in particular of primers, with the automated primer application system according to the invention, the high-pressure waterjet-consolidated polymer-cellulose nonwoven is saturated and, thus, transfers the liquid onto the surface, preferably onto the glass, ceramic, or plastic surface, and in particular onto the main bodies of panes. In contrast to the prior art methods using felt, the high-pressure waterjet-consolidated polymer-cellulose nonwoven absorbs significantly less liquid, in particular significantly less primer, such that at the time of a change or further cycling of the fabric, less liquid, in particular less primer, has to be discarded. In addition, the formation of primer pools and primer runs is reduced. The change of the fabric in the context of the method according to the invention is done using the application system according to the invention via the roller system comprising the output reel and a take-up reel similar to a film reel, wherein in each case the roller system only has to displace the high-pressure waterjet-consolidated polymer-cellulose nonwoven by a few centimeters.

The present invention achieves its advantages in that the primers or other liquids are not applied by felt heads or felt webs, but, rather, by a nozzle with a pretensioned high-pressure waterjet-consolidated polymer-cellulose nonwoven, wherein the liquid saturates the fabric and, thus, the liquid can be transferred to the surface, preferably a glass, ceramic, or plastic surface and, in particular, a main body of a pane for a vehicle window pane. The high-pressure waterjet-consolidated polymer-cellulose nonwoven preferably has a thickness of 0.1 mm to 2 mm, particularly preferably of 0.2 mm to 1 mm. With these material thicknesses, the loss of primer liquid at the time of further cycling of the used soaked nonwoven is advantageously reduced, while, at the same time, the nonwoven demonstrates very good stability.

Considered as polymers of the polymer-cellulose nonwoven are all technical plastics that can form fibers which can be shaped with a high-pressure waterjet without decomposition and can be adhesively bonded with other fibrous materials such as cellulose nonwovens. Thermoplastic polyesters, in particular polyethylene terephthalate (PET), are particularly preferably used. Particularly good results have been obtained with PET-cellulose nonwovens.

Preferably, the high-pressure waterjet-consolidated polymer-cellulose nonwoven contains or is made of, based on its respective total amount, 40 wt.-% to 60 wt.-% polyester and 60 wt.-% to 40 wt.-% cellulose, in particular 48 wt.-% polyester and 52 wt.-% cellulose.

Particularly preferably, the high-pressure waterjet-consolidated polyester-cellulose nonwoven contains or is made of, based on its respective total amount, 40 to 60 wt.-% polyester and 60 to 40 wt.-% cellulose, in particular 48 wt.-% polyester and 52 wt.-% cellulose. Materials of this type are known and are marketed, for example, under the trademark DuPont Sontara® PrintMaster. These Sontara® nonwovens are marketed as specialty washcloths for printers with a turning mechanism and a rough printing cylinder. The Sontara® nonwoven (cf. American patent U.S. Pat. No. 3,837,995) has been used, for example, in surgical face masks (cf. German patent application DE 36 01 449 A1) and in medical cover sheets (cf. European patent EP 0 197 048 B1). Use of the Sontara® nonwovens in the production of attachment parts for means of transportation is not known.

In the context of the present invention, the term “attachment parts for means of transportation” means vehicle windows, vehicle roofs, spoiler elements, pillar covers, roof panels, seals, and trim strips, or the like. The term “means of transportation” means of transportation on land, in particular motor vehicles, buses, or trains, means of transportation in the air, in particular aircraft, balloons, or airships, and means of transportation on water, in particular ships and boats.

The term “vehicle window pane” includes, in the context of the present invention, panes made of mineral glass or plastic. The panes can be designed bent or curved or three-dimensional and have a black border. The black border can be produced by screen printing with a suitable ceramic or organic screen printing paste, or by gate molding of a polymeric material layer. Moreover, the panes can have additional elements, for instance, mounting domes, ornamental decorations, or soft components. In a preferred embodiment, the automated primer application system includes at least one carrier plate and one guide roller. The take-up reel for the used high-pressure waterjet-consolidated polymer-cellulose nonwoven and the output reel for the clean high-pressure waterjet-consolidated polymer-cellulose nonwoven are arranged on the carrier plate. The output reel is rotatably arranged on the carrier plate with the help of one or a plurality of first bushings. The take-up reel is rotatably arranged on the carrier plate with the help of at least one second bushing. The primer application system also includes a guide roller associated with the rotatable output reel. The guide roller is arranged such that the clean high-pressure waterjet-consolidated polymer-cellulose nonwoven is guided from the output reel via the guide roller to the nozzle opening of the application head, where it is soaked with the primer liquid, and fed from there to the take-up reel and is wound up there. By means of the routing of the polymer-cellulose nonwoven via the guide roller, optimal pretensioning of the polymer-cellulose nonwoven is achieved.

In a preferred embodiment of the automated primer application systems, the high-pressure waterjet-consolidated polymer-cellulose nonwoven is guided via the take-up reel, the output reel, the application head with the nozzle opening, and 1 to 3 guide rollers. Due to the properties of the high-pressure waterjet-consolidated polymer-cellulose nonwoven, no complicated transport system is necessary, since good pretensioning is already achieved with a system consisting of only a few rollers. Preferably, only 1 to 2 guide rollers are, particularly preferably only 1 guide roller is part of the automated primer application system. With one guide roller, the system and, thus, also production is more economical and the system requires less space at the production site and can be used more flexibly, even for small parts.

Preferably, the output reel is arranged on the carrier plate above the take-up reel. Thus, no primer liquid adhering to the used polymer-cellulose nonwoven can drip, through the action of gravity, onto the clean polymer-cellulose nonwoven on the output reel.

The width of the polymer-cellulose nonwovens can vary widely and is governed primarily by the desired width of the track applied on the surface. However, it is also possible not to achieve the desired width with one pass of the method according to the invention but rather with multiple passes.

The primer application system according to the invention has an application head that is preferably made of polytetrafluoroethylene (PTFE, Teflon®) or polychlorotrifluoroethylene (PCTFE). This has the advantage that the primer liquid adheres only slightly to the material such that the high-pressure waterjet-consolidated polyester-cellulose nonwoven can be cycled further with no problem.

In a preferred embodiment of the automated primer application system, the application head includes a connector for the primer liquid, which is fed via a supply line from a primer reservoir, as well as a sealing pin, which seals the nozzle opening as soon as the primer application system goes into a parking position.

In the context of the method according to the invention, in the application system PA according to the invention, the dosing of the liquid, in particular of the primer, is done via a flexible tube system, via which the liquid is replenished under pressure control from a reservoir. The exact quantity dosing is done via the reservoir, which is subjected to a slight overpressure. The overpressure can be regulated precisely by a valve. This method enables very precise controllable dosing of the liquid, in particular of the primer, by means of which the material consumption is further reduced and the application efficiency is increased. In the parking position of the application system PA according to the invention, the overpressure in the reservoir is reduced. This prevents liquid from continuing to flow to the application head and dripping. If necessary, the capability of producing a vacuum in the reservoir also exists.

The feeding of the liquid, in particular of the primer, can also be done by gravity in the context of the method according to the invention.

Thus, no movable parts, on which the primer can settle and dry, are necessary for the feeding of the liquid, in particular of the primer, constituting another special advantage of the applicator according to the invention.

In a preferred embodiment of the automated primer application system, a mechanism is arranged on the back of the carrier plate, which mechanism specifies the pace of the feed for the high-pressure waterjet-consolidated polymer-cellulose nonwoven and which includes the following components functionally associated with one another: a timing lever, a lever mounting, a first spring, which exerts a variable force on the timing lever, a ratchet wheel associated with the second take-up reel, a locking lever, which is coupled via a second spring with a pawl, as well as a protective cover for the mechanism. This structure ensures a controlled and particularly efficient forward movement of the high-pressure waterjet-consolidated polymer-cellulose nonwoven. The back of the carrier plate is opposite the side on which the take-up reel and output reel are mounted.

The cycle of the method according to the invention for the controlled application of primer liquids on surfaces of attachment parts for means of transportation with the help of the automated primer application systems according to the invention can be described as follows: First, an attachment part is provided. The application head with the soaked high-pressure waterjet-consolidated polymer-cellulose nonwoven is placed on the surface of the part. Primer liquid is fed to the high-pressure waterjet-consolidated polymer-cellulose nonwoven through the nozzle opening in the application head. The surface of the part or the high-pressure waterjet-consolidated polymer-cellulose nonwoven is moved along the contour to be provided with the primer liquid. In a last step, the contact between application head with the soaked high-pressure waterjet-consolidated polymer-cellulose nonwoven and the surface of the part is released, in other words, the attachment part is removed. With this method, attachment parts for means of transportation can be provided with a primer, in an automated manner, without unattractive primer pools being formed.

The application system according to the invention is preferably moved and controlled according to the contours of the application by a robot. During the application, the liquid or the primer is continuously fed as described above via the application head.

In a preferred embodiment of the method according to the invention, the applicator according to the invention is brought, after the releasing of contact between the application head and the surface of the part, into a waiting position, or in the case of longer stoppage, into a parking position. In the waiting position, the PA stays put until the feed-in of the next part. In the parking position, the nozzle opening for the liquid, in particular the primer, is sealed with a sealing pin. The soaked high-pressure waterjet-consolidated polymer-cellulose nonwoven is cycled one position farther such that clean polymer-cellulose nonwoven is arranged in front of the nozzle opening. This is preferably done with the help of a mechanism that has a lever and a ratchet wheel. The lever itself is actuated by the robot. The sealing of the nozzle opening preferably happens in a simple manner in that the application system according to the invention is lowered onto a sealing pin, whose upper free end is shaped such that it seals the nozzle opening precisely. In another embodiment, the sealing pin can be mounted on a spring such that any existing tolerances of the robot can be compensated.

The sealing pin can pierce the high-pressure waterjet-consolidated polymer-cellulose nonwoven, in particular the polyester-cellulose nonwoven, without the nonwoven tearing.

At the time of restarting, the applicator according to the invention is detached again from the sealing pin, the nozzle opening is released, and the applicator is moved into an application position. In the application position, the application head is again situated above a surface of the part, onto which a liquid is to be applied.

According to the invention, when restarting, it is further advantageous for a forward movement of the high-pressure waterjet-consolidated polymer-cellulose nonwoven or suction webs to occur and for a test application to be carried out on a test strip. The test application can be measured densiometrically or by a scanner. It is thus ensured that the subsequent application of liquid, in particular of primer, will proceed successfully.

Preferably, the surfaces of the parts are glass, ceramic, or plastic surfaces.

The invention further includes the use of a high-pressure waterjet-consolidated polymer-cellulose nonwoven for applying primer liquids during the production of an attachment part for means of transportation. Preferably, the polymer is a polyester, particularly preferably a polyethylene terephthalate (PET).

Preferably, the high-pressure waterjet-consolidated polymer-cellulose nonwovens are used during the production of motor vehicles, in particular during the production of vehicle window panes, vehicle roofs, spoiler elements, roof panels, or trim strips.

In particular, the high-pressure waterjet-consolidated polymer-cellulose nonwovens are used for preparing direct gluing of the vehicle window panes to vehicle bodies.

Of course, the features mentioned above and those explained in detail in the following can be used not only in the combinations and configurations indicated, but also in other combinations and configurations or alone without departing from the scope of the present invention.

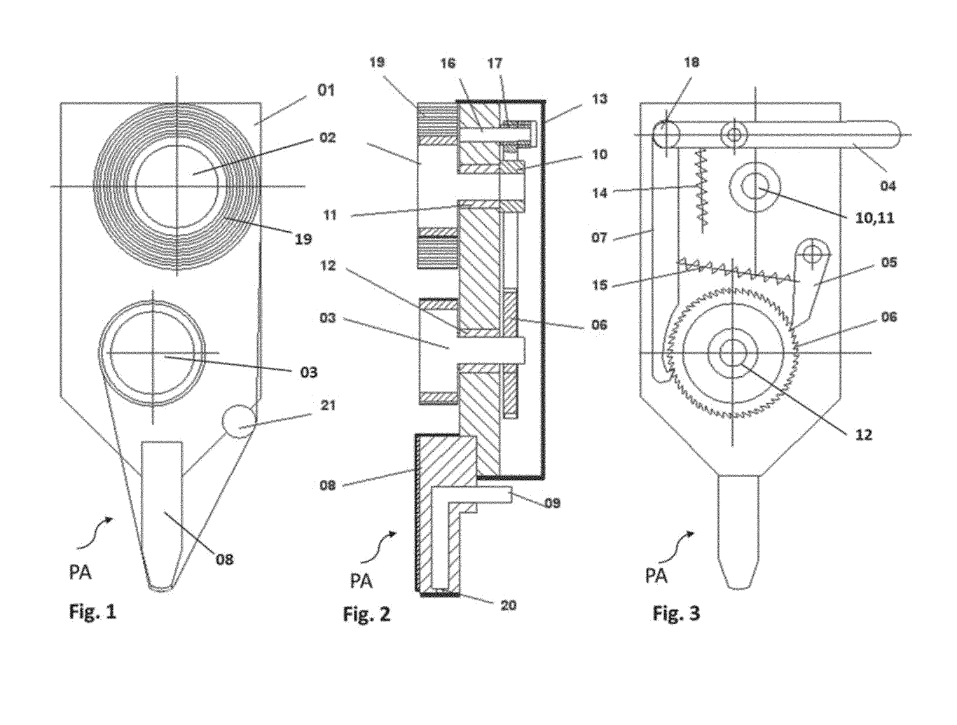

The invention is now explained in detail with reference to exemplary embodiments, referring to the accompanying FIGS. 1 through 5. They depict in simplified, not-to-scale representation:

FIG. 1 a plan view of the front view of the automated primer application system PA;

FIG. 2 a plan view of a longitudinal section through the automated primer application system PA along its centerline;

FIG. 3 a plan view of the back view of the automated primer application systems PA without the protection 13;

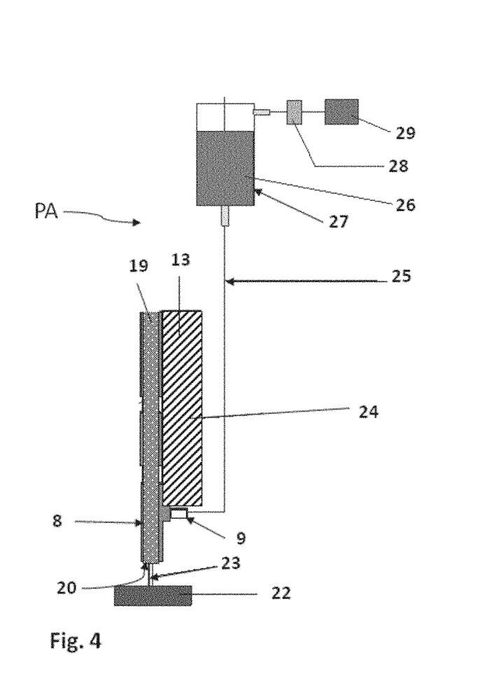

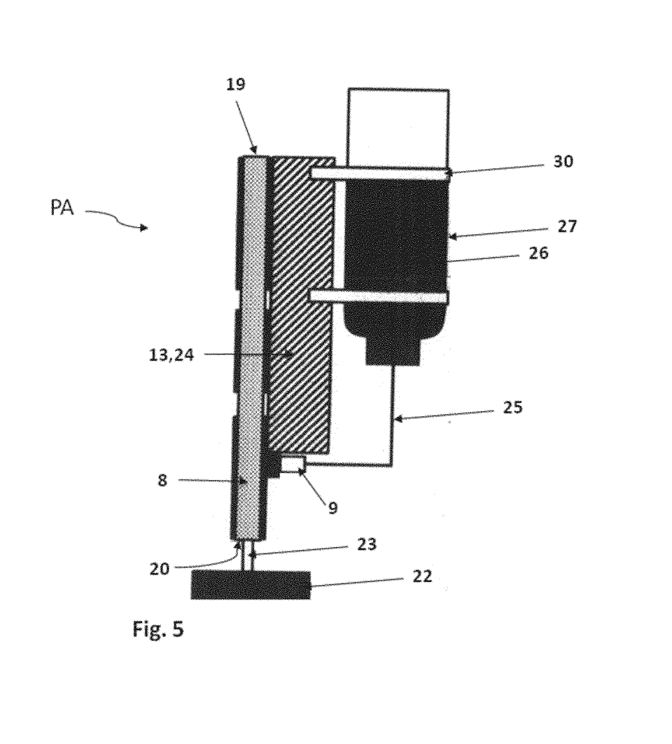

FIG. 4 a plan view of the side view of the automated primer application system PA in the parking position;

FIG. 5 a plan view of the side view of another embodiment of the automated primer application system PA in the parking position.

FIG. 1 depicts a plan view of the front view of the application system PA according to the invention with a carrier plate 01. Arranged in the upper region of the carrier plate 01 is an output reel 02 for the clean suction web 19 having a width of 1.5 cm and a thickness of 1 mm. This output reel 02 is rotatably mounted with the help of the first bushings 10 and 11. Used according to the invention as the suction web 19 is a high-pressure waterjet-consolidated polyester-cellulose nonwoven, which, based on the nonwoven, consists of 48 wt.-% polyester and 52 wt.-% cellulose. The output reel 02 is arranged above the take-up reel 03 for the used suction web 19. The take-up reel 03 is rotatably arranged on the carrier plate with the help of the second bushing 12. Associated with the rotatable output reel 02 is one guide roller 21, from which the clean high-pressure waterjet-consolidated polyester-cellulose nonwoven 19 is guided to the nozzle opening 20 of the application head 8 made of PTFE. There, it is soaked with the primer 26. From the nozzle opening 20, it is fed to a take-up reel 03 rotatably arranged with the help of the second bushing 12 on the carrier plate 01 and wound up there.

The application head 8 is guided with a computer-controlled robot (not shown) over the surface, in particular over the glass, ceramic, or plastic surface of a main body of a pane (not shown), by which means the primer 26 is deposited in the desired configuration.

FIG. 2 depicts the plan view of a longitudinal section along the centerline of the carrier plate 01.

Visible is the application head 08 with the nozzle opening 20 and with the connector 9 for the primer 26. The entire arrangement except for the application head 8 is protected by a protective cover 13 made of plastic or metal.

FIG. 3 depicts a plan view of the back view of the application system PA according to the invention without the protective covering 13. Accordingly, arranged on the back of the carrier plate 01 is a mechanism, which specifies the pace of the feed for the high-pressure waterjet-consolidated polyester-cellulose nonwoven and which, preferably, includes the following components functionally associated with one another:
a timing lever 04,
a lever mounting 18,
a first spring 14, which exerts a variable force on the timing lever 04,
a ratchet wheel 06 associated with the take-up reel 03,
locking lever 07, which is coupled via a second spring with
a pawl 05, as well as
a protective cover 13 for the mechanism.

The pace is specified with the help of a computer-controlled robot.

FIG. 4 depicts an embodiment of the application system PA according to the invention in a side view and a parking position 24. The reservoir 27 for the primer 26 is arranged above the application system PA according to the invention. A feed for compressed air 29 which can be regulated with a compressed air control 28 is situated above the liquid level on the reservoir 27. The reservoir 27 is fluidically connected via the flexible supply line 25 to the connector 9 for primer liquid. The mechanism of FIG. 3 is covered by the protective covering 13. The application head 8 made of PTFE is lowered onto a sealing pin 23, which is mounted on a machine component 22. The sealing pin 23 pierces the suction web 19 and is mounted on a spring such that tolerances of the robot can be compensated thereby. The upper free end of the sealing pin 23 is shaped such that it precisely seals the nozzle opening 20.

At the time of restarting, the applicator according to the invention is again detached from the sealing pin, the nozzle opening is released again, and the applicator is moved into an application position.

According to the invention, it is advantageous, when restarting, first, for a forward movement of the high-pressure waterjet-consolidated polymer-cellulose nonwoven 19 or suction webs 19 to occur and for a test application to be carried out on a test strip. The test application can be measured densiometrically or by a scanner. It is thus ensured that the subsequent application of liquid, in particular primer, will proceed successfully.

FIG. 5 depicts another embodiment of the application system PA according to the invention in a side view and a parking position 24. The application system PA according to the invention corresponds in its features to the application system PA of FIG. 4 according to the invention, except that the primer reservoir 27 is mounted on the protective covering 13 with the help of mounts 30. Here again, the primer reservoir 27 is fluidically connected to the connector 09 via a flexible supply line 25 for the primer 26. In this embodiment, the primer 26 is conveyed from the reservoir 27 via the supply line 25 by gravity to the connector 09 for the primer liquid.

### LIST OF REFERENCE CHARACTERS

PA primer application system

01 carrier plate

02 output reel for the clean web of high-pressure waterjet-consolidated polymer-cellulose nonwoven

03 take-up reel for the used web of high-pressure waterjet-consolidated polymer-cellulose nonwoven

04 timing lever

05 pawl

06 ratchet wheel

07 locking lever

08 application head

09 connector for primer liquid

10 first bushing

11 first bushing

12 second bushing

13 protective covering

14 first spring

15 second spring

16 bolt

17 third bushing

18 lever mounting

19 high-pressure waterjet-consolidated polymer-cellulose nonwoven or suction web

20 nozzle opening

21 guide roller

22 machine component on which the sealing pin 23 is mounted

23 sealing pin

24 applicator in the parking position

25 supply line for the primer liquid 26

26 primer liquid or primer

27 primer reservoir

28 compressed air control

29 compressed air supply

30 mount for the primer reservoir 27

1.-14. (canceled)

15. An automated primer application system for producing attachment parts for means of transportation, comprising:
an output reel;
a take-up reel;
an application head with a nozzle opening; and
a high-pressure waterjet-consolidated polymer-cellulose nonwoven,
wherein the high-pressure waterjet-consolidated polymer-cellulose nonwoven is guided from the output reel over the application head to the take-up reel,
wherein the high-pressure waterjet-consolidated polymer-cellulose nonwoven is arranged in front of the nozzle opening, and
wherein a primer liquid can be fed through the nozzle opening such that the primer liquid can be applied to a surface of a part via the polymer-cellulose nonwoven.

16. The automated primer application system according to claim 15, wherein the polymer is a polyester.

17. The automated primer application system according to claim 16, wherein the polyester is polyethylene terephthalate.

18. The automated primer application system according to claim 15, wherein the high-pressure waterjet-consolidated polymer-cellulose nonwoven contains 40 wt.-% to 60 wt.-% polyester or 60 wt.-% to 40 wt.-% cellulose.

19. The automated primer application system according to claim 15, further comprising a carrier plate and a guide roller,
wherein the output reel for a clean high-pressure waterjet-consolidated polymer-cellulose nonwoven is rotatably arranged on the carrier plate with help of a first bushing,
wherein the take-up reel for the used high-pressure waterjet-consolidated polymer-cellulose nonwoven is rotatably arranged on the carrier plate with help of a second bushing,
wherein associated with the rotatable output reel is the guide roller, from which the clean high-pressure waterjet-consolidated polymer-cellulose nonwoven is guided to the nozzle opening of the application head, where the clean high-pressure waterjet-consolidated polymer-cellulose nonwoven is soaked with the primer liquid,
wherein the high-pressure waterjet-consolidated polymer-cellulose nonwoven is routed from the application head to the take-up reel, and
wherein the high-pressure waterjet-consolidated polymer-cellulose nonwoven is wound upon the take-up reel.

20. The automated primer application system according to claim 15, wherein the high-pressure waterjet-consolidated polymer-cellulose nonwoven is guided over the take-up reel, the output reel, the application head with the nozzle opening, and one to three guide rollers.

21. The automated primer application system according to claim 15,
wherein the application head further comprises a connector for the primer liquid, the connector being fed via a supply line from a primer reservoir, and
wherein the application head further comprises a sealing pin for sealing the nozzle opening when the primer application system goes into a parking position.

22. The automated primer application system according to claim 19, wherein, arranged on the back of the carrier plate, is a mechanism that specifies a pace of a feed for the high-pressure waterjet-consolidated polymer-cellulose nonwoven, the mechanism comprising
a timing lever,
a lever mounting,
a first spring, exerting a variable force on the timing lever,
a ratchet wheel associated with the second take-up reel,
a locking lever coupled via a second spring with a pawl, and
a protective cover for the mechanism.

23. A method for controlled application of primer liquids on surfaces of attachment parts for means of transportation, comprising:
providing an output reel, a take-up reel, an application head with a nozzle opening and a high-pressure waterjet-consolidated polymer-cellulose nonwoven;
guiding the high-pressure waterjet-consolidated polymer-cellulose nonwoven from the output reel over the application head to the take-up reel;
arranging the high-pressure waterjet-consolidated polymer-cellulose nonwoven in front of the nozzle opening;
feeding a primer liquid through the nozzle opening;
providing an attachment part;
placing the application head with a soaked high-pressure waterjet-consolidated polymer-cellulose nonwoven on a surface of the attachment part;
applying the primer liquid to the surface of the attachment part via the polymer-cellulose nonwoven;
providing contours with the primer liquid;
moving the surface of the attachment part or the application head along the contours; and
releasing contact between the application head with a soaked high-pressure waterjet-consolidated polymer-cellulose nonwoven and the surface of the part.

24. The method according to claim 23, further comprising:
after releasing contact between the application head and the surface of the part, placing the high-pressure waterjet-consolidated polymer-cellulose nonwoven one position farther, thereby arranging clean polymer-cellulose nonwoven in front of the nozzle opening,
bringing the output reel, the take-up reel, the application head with a nozzle opening and the high-pressure waterjet-consolidated polymer-cellulose nonwoven into a parking position, and
sealing the nozzle opening with a sealing pin.

25. The method according to claim 23, wherein the surface of the attachment part is glass, ceramic, or plastic.

26. A method, comprising:
providing a high-pressure waterjet-consolidated polymer-cellulose nonwoven soaked with primer liquids; and
using the high-pressure waterjet-consolidated polymer-cellulose nonwoven for applying primer liquids during production of an attachment part for means of transportation.

27. The method according to claim 26, wherein the attachment part for means of transportation is a vehicle window pane, a vehicle roof, a spoiler element, a roof panel, or a trim strip.

28. The method according to claim 26, wherein the polymer is a polyester.

29. The method according to claim 28, wherein the polyester comprises polyethylene terephthalate.
